(19) United States
(12) Patent Application Publication
(10) Pub. No.: US 2011/0263299 A1
(43) Pub. Date: Oct. 27, 2011

(54) VIDEO PROJECTOR

(75) Inventor: Kazunori KOTANI, Nara-shi (JP)

(73) Assignee: Sanyo Electric Co., Ltd., Osaka (JP)

(21) Appl. No.: 13/088,655

(22) Filed: Apr. 18, 2011

(30) Foreign Application Priority Data
Apr. 22, 2010 (JP) 2010-099088

(51) Int. Cl. H04N 5/64; H04M 1/00

(52) U.S. Cl. 455/566; 348/789; 348/E05.128; 348/E09.025

(57) ABSTRACT

A video projector includes a main body serving as a portable unit, which includes a projection optical unit that forms and projects a display image. The main body includes a rechargeable battery serving as a power supply. A holder holds the main body at a predetermined position. The holder includes a screen onto which is projected the display image from the main body held at the predetermined position. The holder is configured to charge the rechargeable battery when the main body is held in the holder.

### CROSS-REFERENCE TO RELATED APPLICATIONS

This application is based upon and claims the benefit of priority from prior Japanese Patent Application No. 2010-099088, filed on Apr. 22, 2010, the entire contents of which are incorporated herein by reference.

### BACKGROUND OF THE INVENTION

The present invention relates to a video projector, and more particularly, to a video projector including a portable projection optical unit, which photo-modulates light from a light source to generate image light.

There are video projectors of a front type and a rear type. A front type video projector includes a projection optical unit that is separated from a screen. The projection optical unit forms and projects a display image and a surface of the screen. The rear type video projector accommodates a projection optical unit in a housing, which includes a screen, to project image light from a rear side of the screen.

The front type video projector is convenient since it is separated from the screen and thus can display an image at any location. Further, the development in the electronic industry and the information and communication technology has enabled the use of high speed Internet service through personal computers and cellular telephones. This, in turn, has resulted in a demand for portable video projectors having high image quality image processing capabilities. The front type video projectors can easily answer such demands.

Japanese Laid-Open Patent Publication No. 2008-58970 describes a foldable portable terminal incorporating a mobile video projector provided with a cellular telephone function. Such a portable terminal includes a wireless communication function, an input function for inputting information, a camera function serving as one input function, a storage function for storing the input information, and a function for reading the stored information and projecting an image of the information on a selected one of an internal display unit and an external display unit.

However, an appropriate wall that may be used as a screen is not always available. Here, an appropriate wall refers to an even plane such as a wall that is white, includes no patterns, and has a predetermined size to enable the projection of a rectangular image. Problems may arise when a wall does not satisfy such conditions. For instance, when the wall is not white, the color of the projected image may differ from the original color. When the wall includes a pattern, the projected image may appear in the projected image. When the wall does not have the predetermined size, part of the projected image may not be shown. When the wall is not an even plane and bumpy, bumps may appear on the image. When such problems arise, the visibility is significantly affected making it difficult to view images.

Further, the front type video projector requires the surrounding area to be dark in order to clearly display an enlarged image on a screen or wall. A clear image can be displayed even if the surrounding is not dark by bringing the projection optical unit close to the screen. However, in such a case, a large image cannot be displayed.

Japanese Laid-Open Patent Publication No. 2003-207740 describes a typical rear type video projector of the prior art that displays a clear enlarged image even when the surrounding is bright. However, in the typical rear type video projector of the prior art, a projection optical unit is integrally incorporated in a housing that includes a screen. As a result, the video projector is difficult to carry around. This adversely affects portability.

To solve this problem, Japanese Laid-Open Patent Publication No. 2007-333755 describes a projector including a projection optical unit, which is a portable unit, and a housing, which includes a dedicated screen and is separated from the projection optical unit. The projector projects images when the projection optical unit is coupled to the housing.

In the projector described in Japanese Laid-Open Patent Publication No. 2007-333755, the projection optical unit is separated from the housing including the screen. Accordingly, thorough studies have not been conducted on how to use the projector when the projection optical unit is a portable unit. Thus, the projector described in Japanese Laid-Open Patent Publication No. 2007-333755 leaves much room for improvement in terms of how it can be used as a portable projector. For instance, the portable projector cannot be used like a cellular telephone, which is a representative example of a portable device.

A cellular telephone is provided with a rechargeable battery, which serves as a power supply, and a holder, which is an accessory provided with a charging function. Thus, when a user comes home, the user places the cellular telephone on the holder to charge the rechargeable battery so that it will be ready when the user leaves his or her home. The holder may be arranged at a location where it catches the eye so that the user can easily check the cellular phone for incoming calls and e-mails during the charging. In particular, when the cellular telephone is provided with functions for viewing TV, reproducing music, and reproducing images, the holder may be arranged at a location where the user can be seated in a posture allowing for the cellular phone to be easily viewed or easily reached by stretching out an arm, such as a table or shelf.

In this manner, a cellular telephone must be convenient when used as a portable device. Accordingly, to use the projection optical unit as a portable unit, the projection optical unit must be convenient like portable devices that have become widely used.

### SUMMARY OF THE INVENTION

One aspect of the present invention is a video projector including a main body serving as a portable unit, which includes a projection optical unit that forms and projects a display image. The main body includes a rechargeable battery serving as a power supply. A holder holds the main body at a predetermined position. The holder includes a screen onto which is projected the display image from the main body held at the predetermined position. The holder is configured to charge the rechargeable battery when the main body is held in the holder.

A further aspect of the present invention is a charger for charging a rechargeable battery arranged in a portable unit provided with an image projecting function. The charger includes a mount that holds the portable unit, a screen onto which an image is projected based on image light from the portable unit held by the mount, and a housing including the mount and the screen. The housing includes a charge circuitry that charges the rechargeable battery of the portable unit.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a video projector according to one embodiment of the present invention in a state in which a main body is detached from the video projector;

FIG. 2A is a plan view showing the main body in the video projector of FIG. 1;

FIG. 2B is a front view showing the main body in the video projector of FIG. 1; and

FIG. 3 is a cross-sectional side view showing a state in which the main body of the video projector of FIG. 1 is attached to a holder.

### DETAILED DESCRIPTION OF THE PREFERRED EMBODIMENTS

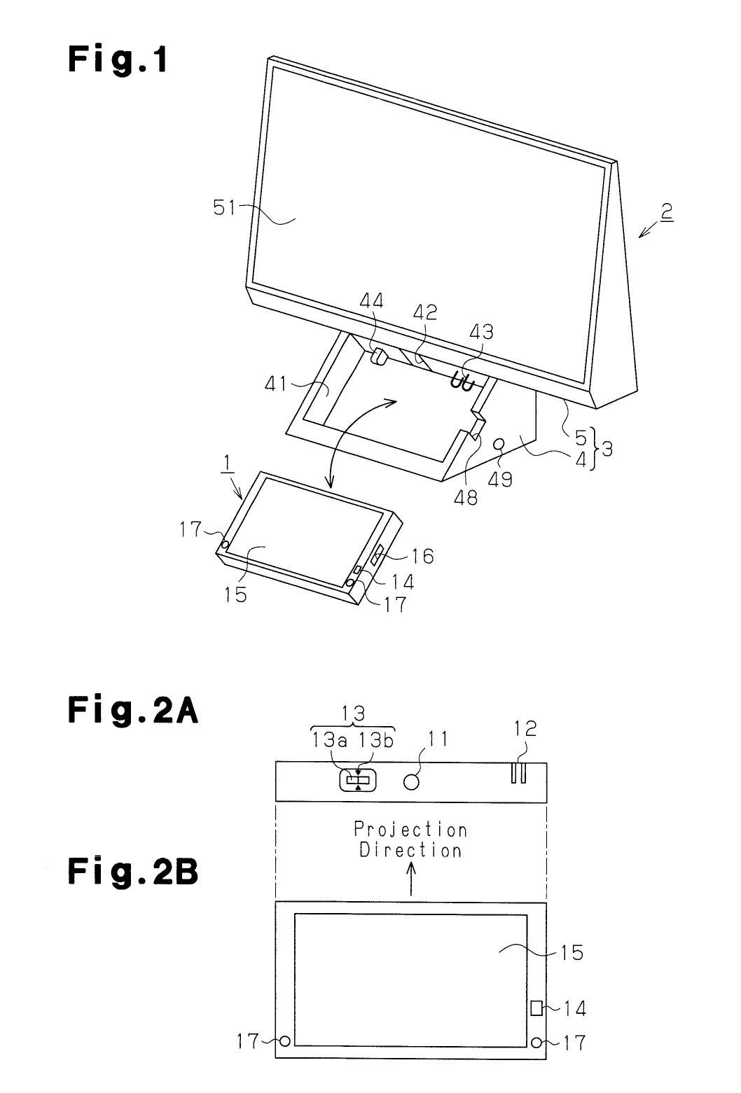

A video projector according to one embodiment of the present invention will now be discussed with reference to FIGS. 1 to 3.

As shown in FIG. 1, the video projector of the present embodiment include a main body 1, which serves as a portable unit including a projection optical unit that forms and projects a display image, and a holder 2, which receives the main body 1 in a mount 41.

The main body 1 is a cellular telephone, which is capable of receiving various types of services from a cellular telephone carrier. The main body 1, or cellular telephone, includes a projection optical unit, which forms and projects a display image. In the same manner as the portable terminal of the prior art, the main body 1 has a wireless communication function, an input function for inputting information, a camera function serving as one input function, and a storage function for storing the input information. The main body 1 also has a function for reading the stored information and projecting a display image of the information on a display unit of the main body 1 or on an external display unit such as a screen. The main body 1 further includes various functions such as a television reception function, an Internet communication function, a video function, a GPS function, a payment function, a word processing and table creation function, a browser function, and the like. The main body 1 also has a function for projecting information generated or retrieved by such functions on the display unit of the main body 1 or an external display unit such as a screen.

The main body 1, which is thin and tetragonal as shown in FIGS. 2A and 2B, is attached in a removable manner to the mount 41 of the holder 2 using elastic force. A projection lens 11, a charge terminal 12 for charging a rechargeable battery, and a lens focus adjustment unit 13 are arranged on an upper surface of the main body 1. The lens focus adjustment unit 13 includes a lens focus dial 13a and a focus marker 13b, which indicates the position to which the lens focus dial 13a is to be adjusted when the main body 1 is attached to the holder 2. The main body 1 is driven using the rechargeable battery as a power supply.

The main body 1 includes a user interface. The user interface includes an operation unit, such as a power switch 14 arranged on a front surface of the main body 1, and a liquid crystal display (LCD) unit 15, which serves as an internal display unit and occupies most of the front surface of the main body 1. In the present embodiment, the LCD unit 15 is of a tough panel type, in which the user operates the main body 1 by touching operation keys displayed on the LCD unit 15. Accordingly, the LCD unit 15 functions not only as a display unit of the main body 1 but also as an operation unit of the main body 1. When the user selects an image key and touches a reproduction key on the LCD unit 15, an image is reproduced on the LCD unit 15. A reproduction menu for reproducing the image by switching to the external display unit is provided as an image reproduction option. When the reproduction menu is selected, a desired image is projected onto an external display unit such as a screen. In the present embodiment, image projection is normally performed when the main body 1 is attached to the holder 2. However, when a suitable transmissive screen can be prepared, the main body 1 may project image light from the rear of the transmissive screen so that an image can be seen from the front of the screen.

When projecting an image on a screen 51 of the holder 2 or on other screens, the image video is displayed on the external display unit, and the LCD unit 15 Of the main body 1 provides an auxiliary display function and an operation function. When displaying an image on the screen 51 of the holder 2, an image display operation and a character input operation may be performed while viewing the screen 51, which is large. Thus, the video projector of the present embodiment may be used in a manner similar to a personal computer.

Image contents that are reproduced include contents retrieved with the various functions described above, such as image contents purchased by the user, contents of images captured by a built-in camera, television contents, and game contents.

The main body 1 includes an internal memory, which serves as a storage device that stores contents downloaded from cellular telephone carriers and the like. A memory card serving as an external storage device may also be connected to the main body 1. As shown in FIG. 1, a memory card insertion port 16 is arranged in a side surface of the main body 1. Speakers 17 are built into the left and right of the front surface of the main body 1.

The holder 2 serves as a charger for charging the rechargeable battery of the main body 1 as well as a support for supporting the main body 1 when the main body 1 projects an image.

The holder 2 includes a housing 3, which is formed by a base 4 and a projection unit 5. The base 4 supports the enter holder 2. The projection unit 5 has a front surface to which the screen 51 is attached.

The base 4, which is box-shape and substantially trapezoidal when viewed from the side, includes a front surface extending diagonally upward. The mount 41 to which the main body 1 is attached is formed in the front surface.

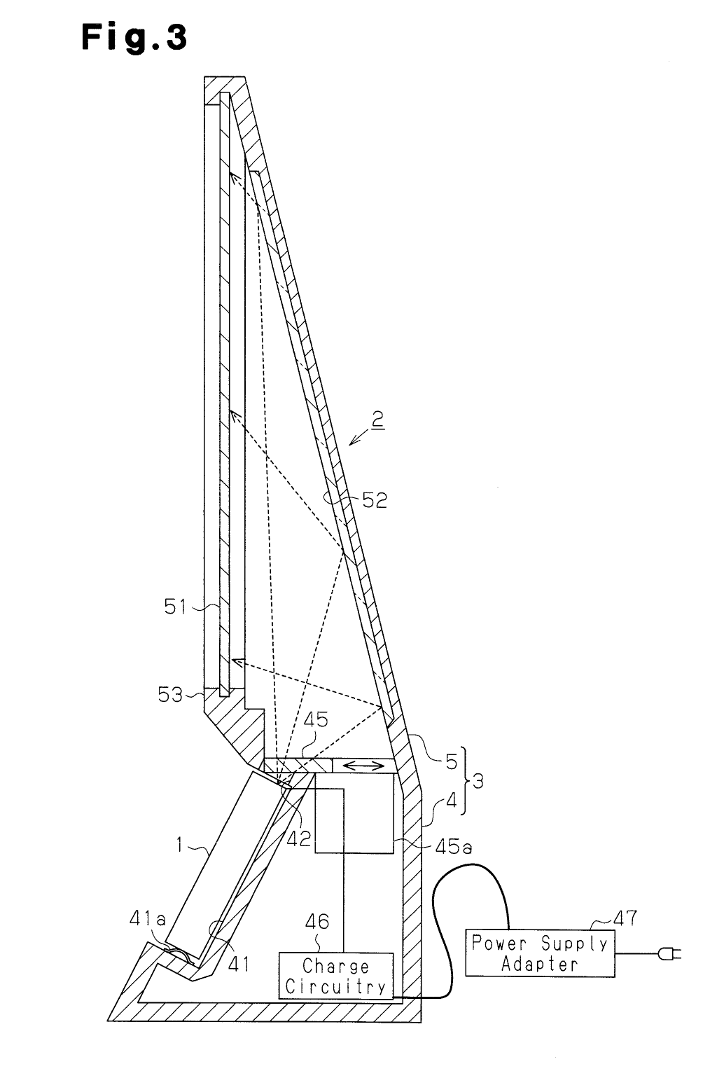

The mount 41 is a generally tetragonal recess occupying most of the front surface of the base 4. As shown in FIG. 3, an elastic member 41a such as a metal spring is arranged in a lower surface of the recess that defines the mount 41. The elastic member 41a elastically fastens the main body 1 to the recess of the mount 41. More specifically, the elastic member 41a applies constant force acting in an upward direction from the lower side of the main body 1.

When seen from the front, the recess of the mount 41 has a size that corresponds to the size of the main body 1 and a depth that is the same or slightly greater than the thickness of the main body 1. The mount 41 is formed so that when the main body 1 is attached, the user interface of the main body 1 is exposed to the exterior to enable the user to operate the main body 1.

As shown in FIG. 1, an inlet 42 is arranged in the upper surface of the recess defining the mount 41. Projection light from the main body 1 enters the projection unit 5 through the inlet 42. The upper surface of the recess further includes a power supply terminal 43, which is coupled to the charge terminal 12 of the main body 1, and a detector 44, which detects attachment of the main body 1 to the mount 41. The detector 44 is formed by switches. The main body 1 is pushed from below against the upper surface of the recess by the constant elastic force. This stabilizes the positional relationship between the main body 1 and the inlet 42 and reduces differences in the state of attachment of the main body 1. Thus, the positional relationship does not adversely affect focusing.

As shown in FIG. 3, the inlet 42 includes a dust shutter 45. The dust shutter 45 slides in forward and rearward directions to open and close the inlet 42 (see arrows extending in the horizontal direction in FIG. 3). FIG. 3 shows the shutter 45 in a closed state. The detector 44 opens the dust shutter 45 when detecting that the main body 1 is attached to the mount 41. A shutter driving mechanism 45a for driving the dust shutter 45 is arranged below the dust shutter 45. The shutter driving mechanism 45a includes a drive unit, such as a motor, and is operated by power supplied from a charge circuitry 46.

The power supply terminal 43 is connected to a commercial power supply by the charge circuitry 46, which is arranged in the base 4, and a power supply adapter 47, which is arranged outside the holder 2 (see FIG. 3). The power supply adapter 47 converts AC current from the commercial power supply into DC current, which is used for charging. Accordingly, the AC current from the commercial power supply is converted by the power supply adapter 47 into DC power and supplied to the charge circuitry 46, which charges the rechargeable battery of the main body 1.

The detector 44 functions to control the opening and closing of a circuit connecting the charge circuitry 46 and the power supply terminal 43. More specifically, when the detector 44 detects that the main body 1 is attached to the mount 41, power is supplied to the rechargeable battery of the main body 1 from the charge circuitry 46 through the power supply terminal 43 and the charge terminal 12. However, when the main body 1 is detached from the mount 41, the circuit is closed so that voltage from the charge circuitry 46 is not applied to the power supply terminal 43.

The detector 44 functions as a control unit of the shutter driving mechanism 45a for driving the dust shutter 45. In other words, the detector 44 controls the shutter driving mechanism 45a to open the dust shutter 45 when detecting that the main body 1 is attached to the mount 41, and close the dust shutter 45 when detecting that the main body 1 is detached from the mount 41.

As shown in FIG. 1, a side surface of the recess defining the mount 41 includes a cutout 48. A memory card may be connected to and disconnected from the main body 1 through the cutout 48, which functions as a service port. A release button 49 is also arranged in the side surface of the base 4 to detach the main body 1 from the holder 2. When the release button 49 is pushed, the main body 1 is lifted and detached from the recess of the mount 41. This allows for the user to easily grasp the main body 1 and completely detach the main body 1 from the holder 2.

The screen 51 is coupled to the front surface of the projection unit 5. A reflection mirror 52 is arranged on an inner rear surface of the projection unit 5. Image light projected from the main body 1 is reflected by the reflection mirror 52 and projected onto the screen 51. In this manner, the holder 2 is of a rear projection type. The broken lines with arrows in FIG. 3 show the light beams of the image light emitted from the main body 1.

The screen 51 is held by a frame 53 in the front surface of the projection unit 5. The screen 51 includes a glass plate serving as a Fresnel sheet, a lenticular sheet, and glass plate serving as a protective plate. The reflection mirror 52 reflects light flux, which becomes parallel when transmitted through the Fresnel sheet. The lenticular sheet diffuses the parallel light flux transmitted through the flannel sheet so that the user can appropriately view a display image. The glass plate serving as the protective plate is formed as the frontmost surface.

In the present embodiment, the reflection mirror 52 directly receives the image light projected from the main body 1 and reflects the image light to the screen at the front surface of the projection unit 5. In this manner, the projection unit 5 is of a so-called rear projection type.

Since the holder 2 is of a rear type, the video projector may be more compact than one of a front type. The video projector of the present embodiment can be arranged on a table or the like so that an image can be viewed while operating the main body 1 from the front. Thus, the video projector can be used in the same manner as a personal computer.

The operation of the video projector will now be described.

The main body 1 also functions as a cellular telephone and may this be used as a cellular telephone by the user.

Referring to FIG. 3, to charge the rechargeable battery of the main body 1, the main body 1 is pushed into the mount 41 of the holder 2 from the front in a diagonal state. When the main body 1 is attached to the mount 41, the charge terminal 12 of the main body 1 comes into contact with the power supply terminal 43 of the mount 41. Then, the power supply adapter 47 of the holder 2 is connected to the commercial power supply to start charging.

To view an image, the main body 1 and the holder 2 are held in the charging state described above. The power switch 14 of the main body 1 is then switched on. This displays the menu and operation keys on the LCD unit 15. The user operates the operation keys in accordance with the menu and selects an image content to view an image. The holder 2 may be used outdoor. Further, when a transmissive screen is prepared and images can be projected onto the transmissive screen from the rear with the main body 1, an image can be viewed without using the holder 2.

To detach the main body 1 from the holder 2, the user pushes the release button 49 of the holder 2 to operate a releasing mechanism (not shown) and push the main body 1 out of the front surface. The user than grasps and detaches the main body 1.

The video projector of the present embodiment has the advantages described below.

(1) The main body 1 and the holder 2, which includes the screen 51, are separate bodies. Thus, the main body 1 has satisfactory portability.

(2) An image can be projected onto the screen 51 by attaching the main body 1 to the holder 2. Thus, a separate screen does not have to be prepared.

(3) The rechargeable battery in the main body 1 is charged when the main body 1 is attached to the holder 2. This facilitates the handling of the portable projector.

(4) The position of the main body 1 is stabilized by attaching the main body 1 to the mount 41. This fixes the positional relationship of the main body 1 and the screen 51. Accordingly, the projection optical unit in the main body 1 is positioned relative to the screen 51 of the holder 2 at the optimum position. Thus, the user does not have to adjust projection position.

(5) The main body 1 includes, on its outer surface, the charge terminal 12 for charging the rechargeable battery. The holder 2 includes the power supply terminal 43 arranged in the mount 41 and coupled to the charge terminal 12 of the main body 1. Thus, image projection and charging are performed in the same attachment state, and the handling of the portable projector is convenient.

(6) The holder 2 includes the housing 3, and the screen 51 is arranged on the front surface of the housing 3. The mount 41 is arranged in the front surface of the housing 3 below the screen 51. The housing 3 accommodates the reflection mirror 52, which is arranged at the rear of the screen 51. The reflection mirror 52 reflects the image light from the main body 1, which is attached to the mount 41, to project a display image on the screen 51. In this manner, the housing also accommodates an optical system of a rear type. Accordingly, the video projector is more compact than a front type video projector. Thus, there are fewer limitations on where the video projector of the present embodiment can be used. In particular, when the video projector is arranged on a table or desk where space is limited, the video projector occupies less space and is thus desirable. Further, when projecting a display image on the screen 51 of the holder 2, the video projector is easily operated.

(7) The main body 1 includes the user interface, which is exposed from the main body 1 when attached to the mount 41. The interface portion functions not only as a display unit but also as an operation unit. Accordingly, the operation unit may be operated to use not only the image projection function but also to use other functions such as the game function. Further, the user interface of the main body 1 eliminates the need for a dedicated controller.

(8) The holder 2 includes the inlet 42, which is formed in the mount 41. Image light from the main body 1 enters the housing 3 through the inlet 42. The dust shutter 45 is arranged at the inlet 42. The dust shutter 45 closes the inlet 42 when the main body 1 is not attached to the mount 41. When the shutter 45 opens the inlet 42, the image light from the main body 1 enters the housing 3 through the inlet 42. When the shutter 45 closes the inlet 42, the dust is prevented from entering the housing 3 through the inlet 42.

(9) The detector 44 detects whether or not the main body 1 is attached to the mount 41. The detector 44 automatically closes the dust shutter 45 when detecting that the main body 1 is not attached to the mount 41. Thus, the dust shutter 45 is prevented from being left open when the main body 1 is removed from the mount 41. Since dust is shut out, the quality of an image is prevented from being influenced by dust.

(10) The main body 1 includes the lens focus adjustment unit 13 for focus adjustment. The lens focus adjustment unit 13 includes the lens focus dial 13a, which is used for focus adjustment, and the focus marker 13b, which indicates the position to which the lens focus dial 13a should be adjusted when the main body 1 is attached to the mount 41.

The focus marker 13b is arranged on the side surface of the main body 1 that faces toward the housing 3. The focus adjustment of the main body 1 is easily performed by aligning the lens focus dial 13a of the lens focus adjustment unit 13 with the focus marker 13b before attaching the main body 1 to the holder 2.

(11) The main body 1 also functions used as a cellular telephone. This increases the significance of the main body 1 being portable. By projecting and displaying in an enlarged manner the contents retrieved by the cellular telephone onto a screen, the main body 1 may be used like a personal computer rather than a cellular telephone.

It should be apparent to those skilled in the art that the present invention may be embodied in many other specific forms without departing from the spirit or scope of the invention. Particularly, it should be understood that the present invention may be embodied in the following forms.

In the embodiment discussed above, focus adjustment is performed by using the lens focus dial 13a. However, a drive unit for focus adjustment may be arranged in the main body 1. In this case, the operation keys and focus adjustment menu displayed on the LCD unit 15 may be used to operate a drive unit for focus adjustment.

The optical system in the projection unit 5 of the embodiment discussed above is of a rear type that projects image light with the single reflection mirror 52. However, the optical system may be of a rear type that projects image light with a plurality of mirrors, such as aspheric mirrors, as described in Japanese Laid-Open Patent Publication No. 2003-207740.

The main body 1 in the embodiment discussed above is a cellular telephone including a projection optical system. However, instead of a cellular telephone, the main body 1 may be a pocket size video projector, a digital camera, a portable game machine, a portable media player, a personal digital assistant (PDA), a mobile PC, or the like.

In the above description, there is no discussion of the light source of the main body 1. However, an LED may be used as the light source. Further, a module using a DMD or a module using a reflective or transmissive LCD may be used as a light modulator of an image generation unit.

In the embodiment discussed above, the touch panel type LCD unit 15 also functions as an operation unit. However, a separate operation unit may be prepared.

The present examples and embodiments are to be considered as illustrative and not restrictive, and the invention is not to be limited to the details given herein, but may be modified within the scope and equivalence of the appended claims.

What is claimed is:

1. A video projector comprising:
a main body serving as a portable unit, which includes a projection optical unit that forms and projects a display image, wherein the main body includes a rechargeable battery serving as a power supply; and
a holder that holds the main body at a predetermined position, wherein the holder includes a screen onto which is projected the display image from the main body held at the predetermined position;
wherein the holder is configured to charge the rechargeable battery when the main body is held in the holder.

2. The video projector according to claim 1, wherein the holder includes a mount that fixes an attachment position of the main body relative to the holder.

3. The video projector according to claim 2, wherein
the main body includes an outer surface,
the outer surface of the main body includes a charge terminal used to charge the rechargeable battery, and
the holder includes a power supply terminal arranged on the mount and connectable to the charge terminal of the main body.

4. The video projector according to claim 2, wherein the holder includes a housing having a front surface on which the screen is arranged, and the mount is arranged in the front surface of the housing below the screen, the video projector further comprises:
a rear type optical system arranged in the housing, the optical system including a reflection mirror arranged at a rear side of the screen, wherein the optical system reflects image light from the main body attached to the mount with the reflection mirror to project the display image on the screen.

5. The video projector according to claim 2, wherein the main body includes a user interface exposed from the mount when attached to the mount, and the user interface functions as an operation unit and a display unit.

6. The video projector according to claim 4, wherein the holder includes:
an inlet formed in the mount, wherein the image light from the main body enters the housing through the inlet; and
a dust shutter arranged at the inlet, wherein the dust shutter closes the inlet when the main body is detached from the mount.

7. The video projector according to claim 6, wherein the holder includes a detector that detects whether or not the main body is attached to the mount, and the detector automatically closes the inlet with the dust shutter when detecting that the main body is not attached to the mount.

8. The video projector according to claim 2, wherein the main body includes a lens focus adjustment unit that performs focus adjustment, and the lens adjustment unit includes:
a lens focus dial used to perform the focus adjustment; and
a focus marker that indicates a position to where the lens focus dial should be adjusted when the main body is attached to the mount.

9. The video projector according to claim 1, wherein the main body has a telephone function.

10. A charger for charging a rechargeable battery arranged in a portable unit provided with an image projecting function, the charger comprising:
a mount that holds the portable unit;
a screen onto which an image is projected based on image light from the portable unit held by the mount; and
a housing including the mount and the screen, wherein the housing includes a charge circuitry that charges the rechargeable battery of the portable unit.
